(19) United States
(12) Patent Application Publication
(10) Pub. No.: US 2009/0212084 A1
(43) Pub. Date: Aug. 27, 2009

(54) Connection device for removable storage basket for bicycles

(76) Inventor: Owen Lee, Taichung (TW)

Correspondence Address: Owen Lee, P.O. Box 44-2049, Taipei, 10668, TW

(21) Appl. No.: 12/071,416

(22) Filed: Feb. 21, 2008

(51) Int. Cl. B62J 7/06

(52) U.S. Cl. 224/420

(57) ABSTRACT

A storage basket includes two handles pivotably connected thereto which include two L-shaped insertions extending from a rear end of the basket. A connection device includes two parallel rods and each rod includes a first hook removably engaged with two holes in the bottom of the storage basket and a second hook removably hooked to the handlebar of the bicycle. A transverse bar is connected between the two rods and includes two collars with which the two L-shaped insertions of the storage basket are removably engaged. A support member is connected between the two rods and removably secured to the head tube of the bicycle.

### BACKGROUND OF THE INVENTION

(1) Field of the Invention

The present invention relates to a connection device for a storage basket which is removably connected to the handlebar and head tube of a bicycle.

(2) Description of the Prior Art

A conventional storage basket for bicycles generally includes two connection plates and bolts are used to fix the two connection plates to the bicycle frame. The storage basket cannot be removed from the bicycle. Some removable storage baskets are developed and can be used as a shopping basket when needed. There is a connection device located between the storage basket and the bicycle and most of the conventional connection devices either includes a weak structure, or is inconvenient for operation.

The present invention intends to provide a connection device for easily mounting a removable storage basket to a bicycle or dismounting the storage basket from the bicycle.

### SUMMARY OF THE INVENTION

The present invention relates to a storage basket that has two handles pivotably connected to the storage basket and including two L-shaped insertions extending from a rear end of the basket. The connection device includes two parallel rods and each rod includes a first hook and a second hook, the first hooks removably hook with two holes located at an underside of the storage basket and the two second hooks removably hook to a handlebar of a bicycle. A transverse bar is connected between the two rods and includes two collars with which the two L-shaped insertions of the storage basket are removably engaged. A support member is connected between the two rods and removably secured to a head tube of the bicycle.

The primary object of the present invention is to provide a removable storage basket for bicycles and the storage basket can be firmly connected to the handlebar and the head tube of the bicycle.

Another object of the present invention is to provide a removable storage basket for bicycles wherein the storage basket can be easily removed from the bicycle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the storage basket and the connection device of the present invention;

FIG. 2 is a perspective view to show the connection device of the present invention;

FIG. 3 is a perspective view to show that the connection device of the present invention is installed to a bicycle;

FIG. 4 is a perspective view to show that the storage basket is connected to the bicycle by the connection device of the present invention;

FIG. 5 is a side view to show that the storage basket is connected to the bicycle by the connection device of the present invention;

FIG. 6 shows the fastening member cooperated with the support member of the connection device of the present invention;

FIG. 7 shows that the two L-shaped insertions are engaged with the two collars on the connection device when the handles of the storage basket are located horizontally, and FIG. 8 shows that the two L-shaped insertions are pivoted vertically and ready disengaged from the two collars on the connection device when the handles of the storage basket are located vertically.

### DETAILED DESCRIPTION OF THE PREFERRED EMBODIMENTS

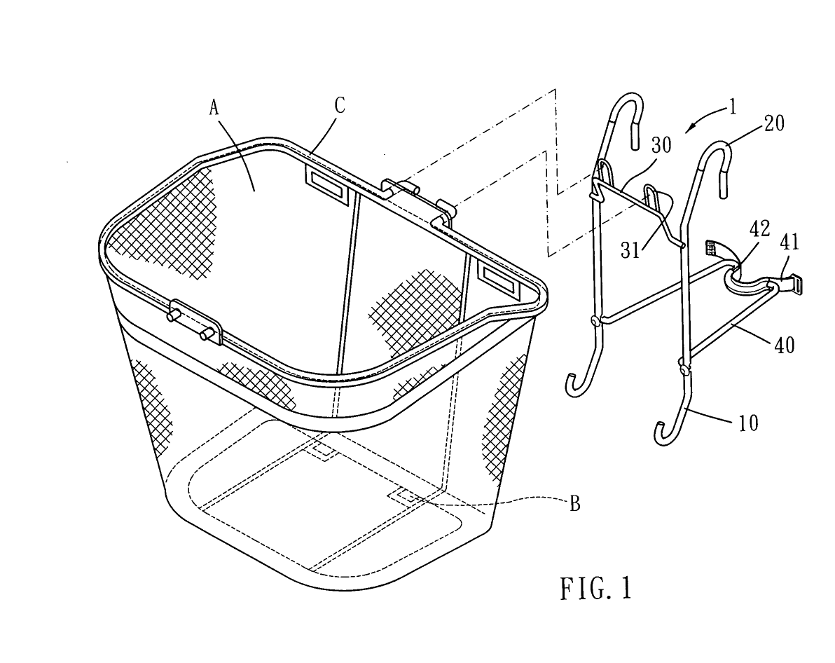

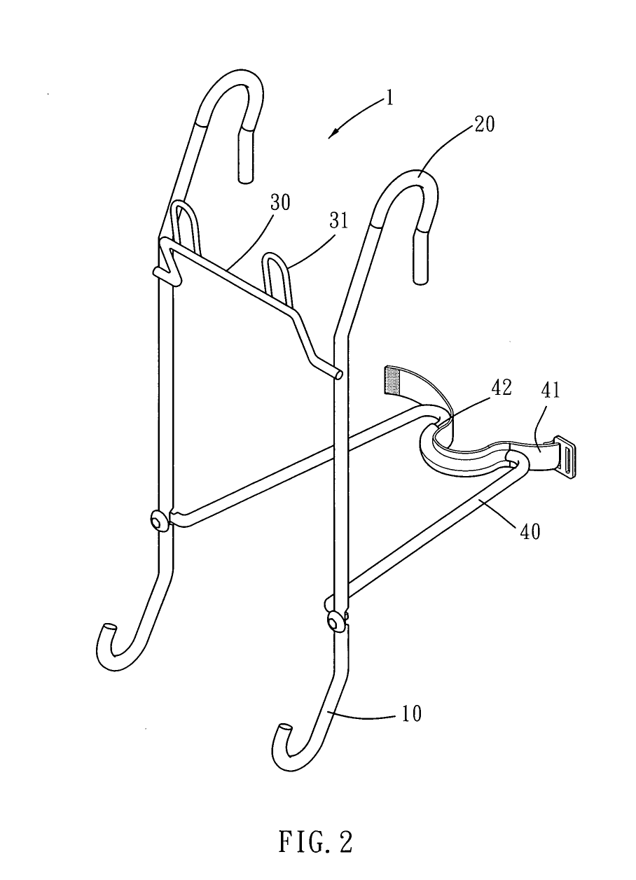

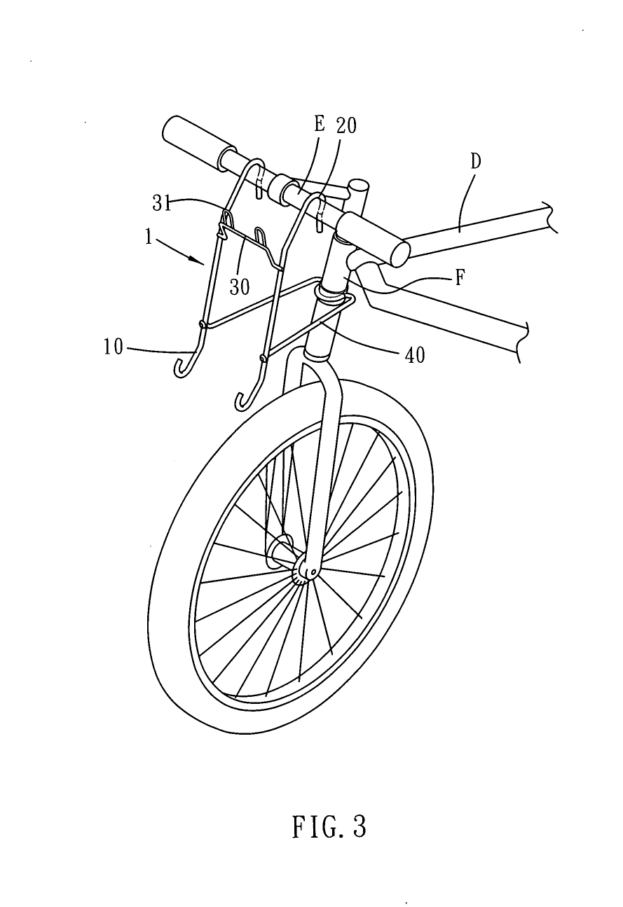

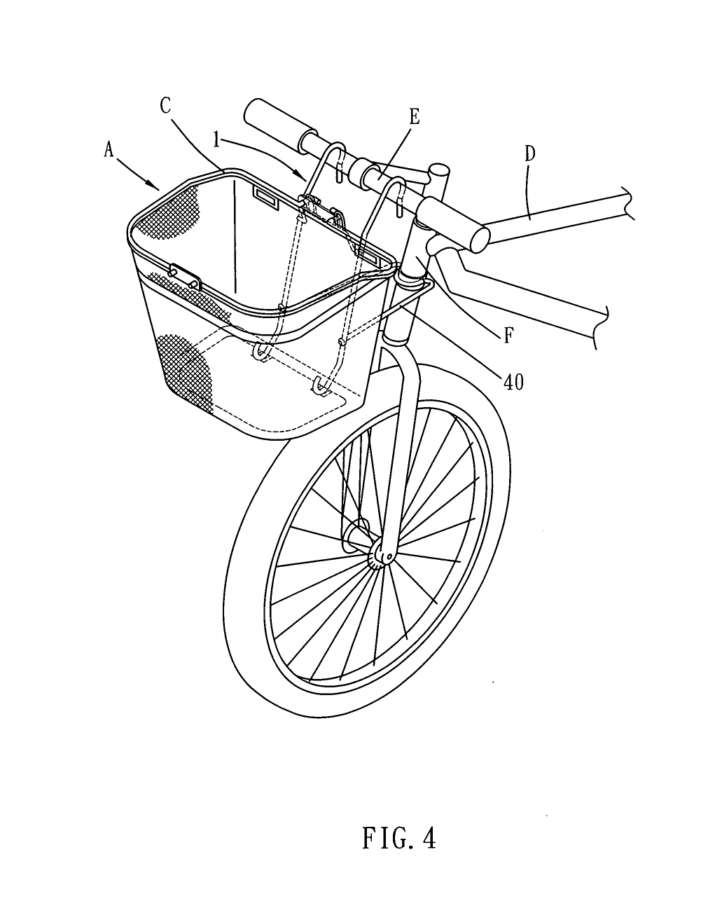

Referring to FIGS. 1 to 4, the storage basket “A” of the present invention comprises two handles “C” pivotably connected to the storage basket “A” and the handles “C” include two L-shaped insertions extending from a rear end of the basket “A”. Two holes “B” are defined in an underside of the storage basket “A”.

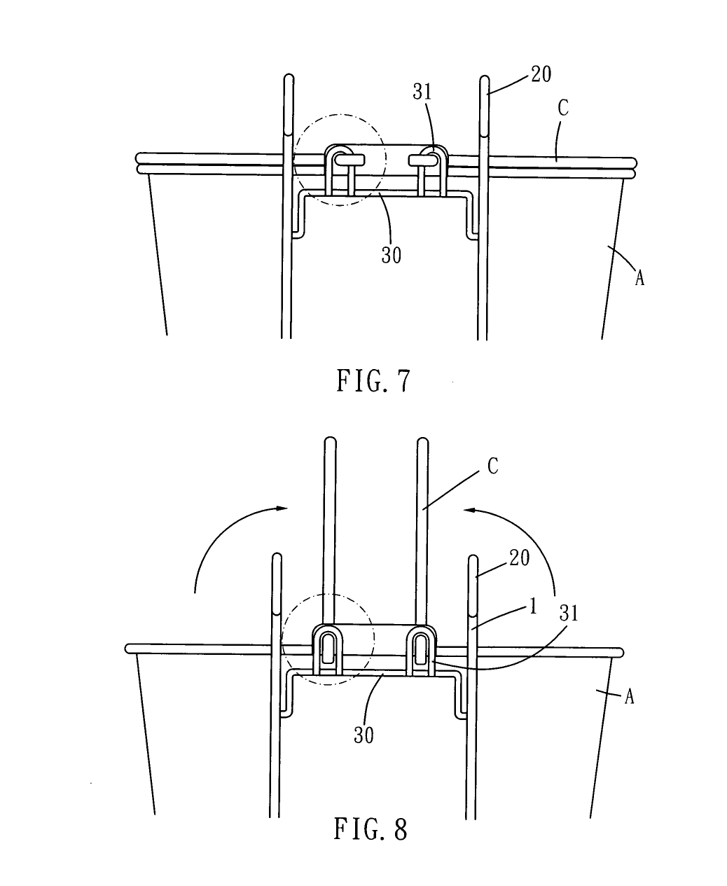

The connection device 1 includes two parallel rods and each rod includes a first hook 10 extending from a lower end thereof and toward the storage basket “A”. Each rod further includes a second hook 20 extending from a top end thereof and toward away from the storage basket “A”. The first hooks 10 are removably hooked with the two holes “B” at the underside of the storage basket “A” and the two second hooks 20 are removably hooked to the handlebar “E” of the bicycle “D”. A transverse bar 30 is connected between the two rods and includes two collars 31 with which the two L-shaped insertions of the storage basket are removably engaged. Referring to FIG. 7, the two collars 31 are elongate collars 31 and extend vertically from the transverse bar 30 so that the two elongate holes in the two collars 31 are oriented vertically relative to the transverse bar 30. The two insertions of the handles “C” are located at a top of the rear end of the storage basket “A” and lie horizontally when the handles “C” are rested on the top of the storage basket “A”.

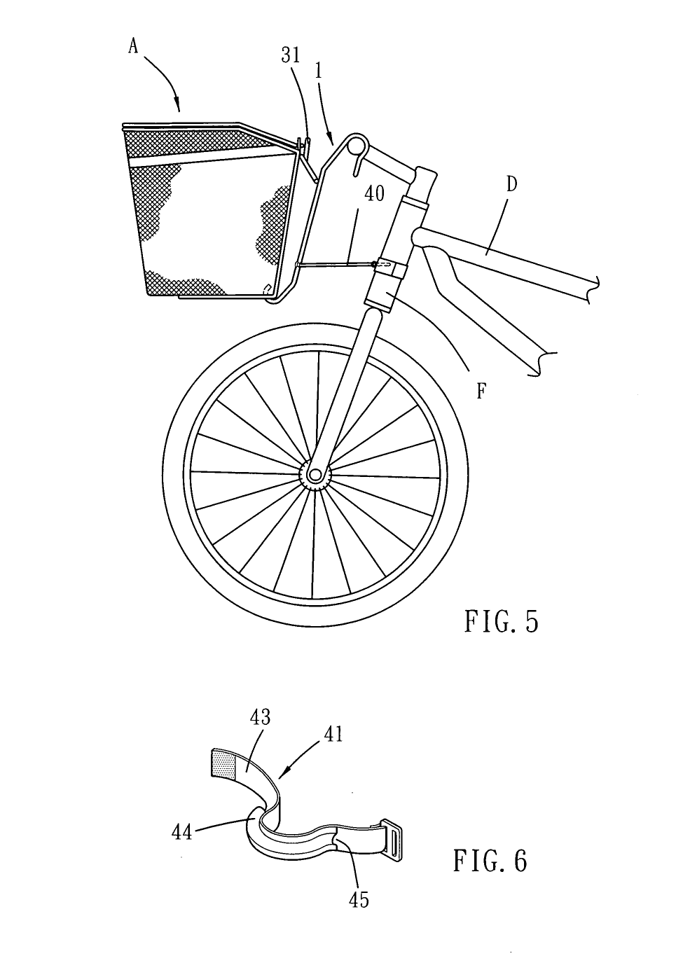

Further referring to FIGS. 5 and 6, a U-shaped support member 40 is connected between the two rods and removably and includes two distal ends fixed to the two rods respectively. The support member 40 includes a recessed portion 42 located at the end opposite to the two distal ends and a fastening member 41 is connected to the recessed portion 42. The head tube “F” of the bicycle “D” is engaged with the recessed portion 42 and the fastening member 41 is fastened to the head tube “F”. The fastening member 41 includes a first belt 44 and a second belt 43, a passage is defined between the first belt 44 and the second belt 43. The recess portion 42 of the support member 40 extends through the passage. Two loop-hook pads are connected to two ends of the second belt 43 so as to be wrapped around the head tube “F” and secured to the head tube “F”.

Referring to FIG. 8, when removing the storage bracket “A” from the bicycle “D”, the user simply separates the two loop-hook pads from each other and pivots the handles “C in vertical direction so that the two insertions are pivoted vertically as shown in FIG. 8. Because the two elongate holes of the collars 31 are oriented vertically, such that when the user lifts the storage basket “A”, the two insertions are disengaged from the collars 31 and the storage basket “A” is easily disengaged from the bicycle “D”.

While we have shown and described the embodiment in accordance with the present invention, it should be clear to those skilled in the art that further embodiments may be made without departing from the scope of the present invention.

What is claimed is:

1. A combination of a storage basket and a connection device, wherein:
two handles pivotably are connected to the storage basket and include two L-shaped insertions extending from a rear end of the basket, the connection device includes two parallel rods and each rod includes a first hook extending from a lower end thereof and toward the storage basket, each rod further includes a second hook extending from a top end thereof and toward away from the storage basket, the first hooks removably hook with two holes located at an underside of the storage basket, the two second hooks are adapted to removably hook to a handlebar of a bicycle, a transverse bar is connected between the two rods and includes two collars with which the two L-shaped insertions of the storage basket are removably engaged, a support member is connected between the two rods and removably and adapted to be secured to a head tube of the bicycle.

2. The combination as claimed in claim 1, wherein the two collars are elongate collars and extend vertically from the transverse bar, the two insertions of the handles are located at a top of the rear end of the storage basket and lie horizontally when the handles are rested on the top of the storage basket, the two insertions of the handles are pivoted in vertical direction when the handles are pivoted vertically.

3. The combination as claimed in claim 1, wherein the support member is a U-shaped member which includes two distal ends fixed to the two rods respectively, the support member includes a recessed portion and a fastening member is connected to the recessed portion, the fastening member is adapted to be fastened to a head tube of the bicycle.

4. The combination as claimed in claim 3, wherein the fastening member includes a first belt and a second belt, a passage is defined between the first belt and the second belt, the recess portion of the support member extends through the passage, two loop-hook pads are connected to two ends of the second belt.
